(19) United States
(12) Patent Application Publication
(10) Pub. No.: US 2007/0052627 A1
(43) Pub. Date: Mar. 8, 2007

(54) Plasma display apparatus and method of driving the same

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/515,010

(22) Filed: Sep. 5, 2006

(30) Foreign Application Priority Data
Sep. 6, 2005 (KR) 10-2005-0082926

(51) Int. Cl. G09G 3/28

(52) U.S. Cl. 345/68

(57) ABSTRACT

A plasma display apparatus and a method of driving the same are disclosed. The plasma display apparatus includes a plasma display panel including a first scan electrode, a second scan electrode, a first sustain electrode corresponding to the first scan electrode and a second sustain electrode corresponding to the second scan electrode, a scan driver and a sustain driver. The scan driver supplies a set-down pulse falling from a first voltage to a second voltage to the first and second scan electrodes during a set-down period, and supplies a first scan pulse to the first scan electrode and a second scan pulse to the second scan electrode during an address period. The sustain driver forms a gradually falling voltage in the second sustain electrode during at least a portion of a total period of time when the set-down pulse is supplied.

This Nonprovisional application claims priority under 35 U.S.C. § 119(a) on Patent Application No. 10-2005-0082926 filed in Korea on Sep. 6, 2005 the entire contents of which are hereby incorporated by reference.

### BACKGROUND

1. Field

This document relates to a plasma display apparatus and a method of driving the same.

2. Description of the Related Art

A plasma display apparatus displays an image using light generated when ultraviolet rays generated by a discharge of an inert mixture gas excites a phosphor.

The plasma display apparatus is driven in a time-division manner by dividing a frame into several subfields having a different number of emission times to achieve gray level of the image. Each of the subfields is subdivided into a reset period for initializing a discharge cell, an address period for selecting a discharge cell to be discharged and a sustain period for achieving gray level.

During the reset period, a sufficient amount of wall charges are accumulated on all discharge cells, and a predetermined amount of wall charges are then erased, thereby initializing all the discharge cells.

During the address period, a scan pulse is supplied to a scan electrode, and a data pulse synchronized with the scan pulse is supplied to an address electrode, thereby selecting the address cell.

During the sustain period, a sustain pulse is supplied to at least one of the scan electrode and a sustain electrode, thereby generating a sustain discharge in the discharge cell selected during the address period.

### SUMMARY

In one aspect, a plasma display apparatus comprises a plasma display panel comprising a first scan electrode supplied with a first scan pulse, a second scan electrode supplied with a second scan pulse after supplying the first scan pulse, a first sustain electrode corresponding to the first scan electrode, and a second sustain electrode corresponding to the second scan electrode, a scan driver for supplying a set-down pulse falling from a first voltage to a second voltage to the first scan electrode and the second scan electrode during a set-down period, and for supplying the first scan pulse to the first scan electrode and the second scan pulse to the second scan electrode during an address period, and a sustain driver for forming a gradually falling voltage in the second sustain electrode during at least a portion of a total period of time when the set-down pulse is supplied.

In another aspect, a method of driving a plasma display apparatus comprising a first scan electrode, a second scan electrode, a first sustain electrode corresponding to the first scan electrode and a second sustain electrode corresponding to the second scan electrode, the method comprises supplying a set-down pulse falling from a first voltage to a second voltage during a set-down period to the first scan electrode and the second scan electrode, forming a gradually falling voltage in the second sustain electrode during at least a portion of a total period of time when the set-down pulse is supplied to the second scan electrode, supplying the first scan pulse to the first scan electrode, and supplying the second scan pulse to the second scan electrode.

In still another aspect, a plasma display apparatus comprises a plasma display panel comprising a first scan electrode supplied with a first scan pulse, a second scan electrode supplied with a second scan pulse after supplying the first scan pulse, a first sustain electrode corresponding to the first scan electrode, and a second sustain electrode corresponding to the second scan electrode, a scan driver for supplying a first set-down pulse falling from a first voltage to a second voltage to the first scan electrode and a second set-down pulse falling from the first voltage to a third voltage with a magnitude more than a magnitude of the second voltage to the second scan electrode during a set-down period, and for supplying the first scan pulse to the first scan electrode and the second scan pulse to the second scan electrode during an address period, and a sustain driver for forming a gradually falling voltage in the second sustain electrode during at least a portion of a total period of time when the second set-down pulse is supplied to the second scan electrode.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates a plasma display apparatus according to a first embodiment;

FIG. 2 illustrates a waveform of a driving signal of the plasma display apparatus according to the first embodiment;

FIG. 3 illustrates a plasma display apparatus according to a second embodiment;

FIG. 4 illustrates a waveform of a driving signal of the plasma display apparatus according to the second embodiment;

FIG. 5 illustrates a driving signal supplied during a set-down period in the driving signal of the plasma display apparatus according to the second embodiment;

FIG. 6 illustrates a plasma display apparatus according to a third embodiment;

FIG. 7 illustrates a waveform of a driving signal of the plasma display apparatus according to the third embodiment;

FIG. 8 illustrates a plasma display apparatus according to a fourth embodiment; and

FIG. 9 illustrates a waveform of a driving signal of the plasma display apparatus according to the fourth embodiment

### DETAILED DESCRIPTION OF PREFERRED EMBODIMENTS

Preferred embodiments of the present invention will be described in a more detailed manner with reference to the drawings.

A plasma display apparatus according to embodiments comprises a plasma display panel comprising a first scan electrode supplied with a first scan pulse, a second scan electrode supplied with a second scan pulse after supplying the first scan pulse, a first sustain electrode corresponding to the first scan electrode, and a second sustin electrode corresponding to the second scan electrode, a scan driver for supplying a set-down pulse falling from a first voltage to a second voltage to the first scan electrode and the second scan electrode during a set-down period, and for supplying the first scan pulse to the first scan electrode and the second scan pulse to the second scan electrode during an address period, and a sustain driver for forming a gradually falling voltage in the second sustain electrode during at least a portion of a total period of time when the set-down pulse is supplied.

The sustain driver may cause the second sustain electrode to be placed in a floating state to form the gradually falling voltage in the second sustain electrode.

The plasma display apparatus may further comprise another sustain driver for supplying a bias voltage to the first sustain electrode during the set-down period.

The plasma display apparatus may further comprise another sustain driver for forming a gradually falling voltage in the first sustain electrode during a second period of a duration less than a duration of a first period during which the gradually falling voltage is formed in the second sustain electrode.

The another sustain driver may cause the first sustain electrode to be placed in a floating state to form the gradually falling voltage in the first sustain electrode.

The second voltage may be more than a lowest voltage of the first scan pulse and a lowest voltage of the second scan pulse.

The second voltage may be substantially equal to a lowest voltage of the first scan pulse and a lowest voltage of the second scan pulse.

A voltage of the set-down pulse supplied to the first scan electrode and the second scan electrode may be maintained at the second voltage for a predetermined period of time.

The predetermined period of time may range from 10% to 50% of a total duration of the set-down period.

A method of driving a plasma display apparatus comprising a first scan electrode, a second scan electrode, a first sustain electrode corresponding to the first scan electrode and a second sustain electrode corresponding to the second scan electrode according to the embodiments, the method comprises supplying a set-down pulse falling from a first voltage to a second voltage during a set-down period to the first scan electrode and the second scan electrode, forming a gradually falling voltage in the second sustain electrode during at least a portion of a total period of time when the set-down pulse is supplied to the second scan electrode, supplying the first scan pulse to the first scan electrode, and supplying the second scan pulse to the second scan electrode.

The second sustain electrode may be placed in a floating state to form the gradually falling voltage in the second sustain electrode.

A bias voltage may be supplied to the first sustain electrode during the set-down period.

A gradually falling voltage may be formed in the first sustain electrode during a second period of a duration less than a duration of a first period during which the gradually falling voltage is formed in the second sustain electrode.

The first sustain electrode may be placed in a floating state to form the gradually falling voltage in the first sustain electrode.

The second voltage may be more than a lowest voltage of the first scan pulse and a lowest voltage of the second scan pulse.

The second voltage may be substantially equal to a lowest voltage of the first scan pulse and a lowest voltage of the second scan pulse.

A voltage of the set-down pulse supplied to the first scan electrode and the second scan electrode may be maintained at the second voltage for a predetermined period of time.

The predetermined period of time may range from 10% to 50% of a total duration of the set-down period.

A plasma display apparatus according to the embodiments comprises a plasma display panel comprising a first scan electrode supplied with a first scan pulse, a second scan electrode supplied with a second scan pulse after supplying the first scan pulse, a first sustain electrode corresponding to the first scan electrode, and a second sustain electrode corresponding to the second scan electrode, a scan driver for supplying a first set-down pulse falling from a first voltage to a second voltage to the first scan electrode and a second set-down pulse falling from the first voltage to a third voltage with a magnitude more than a magnitude of the second voltage to the second scan electrode during a set-down period, and for supplying the first scan pulse to the first scan electrode and the second scan pulse to the second scan electrode during an address period, and a sustain driver for forming a gradually falling voltage in the second sustain electrode during at least a portion of a total period of time when the second set-down pulse is supplied to the second scan electrode.

The sustain driver may cause the second sustain electrode to be placed in a floating state to form the gradually falling voltage in the second sustain electrode.

The plasma display apparatus may further comprise another sustain driver for supplying a bias voltage to the first sustain electrode during the set-down period.

The plasma display apparatus may further comprise another sustain driver for forming a gradually falling voltage in the first sustain electrode during a period of time shorter than a period of time during which a voltage difference between the second scan electrode and the second sustain electrode decreases.

The another sustain driver may cause the first sustain electrode to be placed in a floating state to form the gradually falling voltage in the first sustain electrode.

Hereinafter, exemplary embodiments of the present invention will be described in detail with reference to the attached drawings.

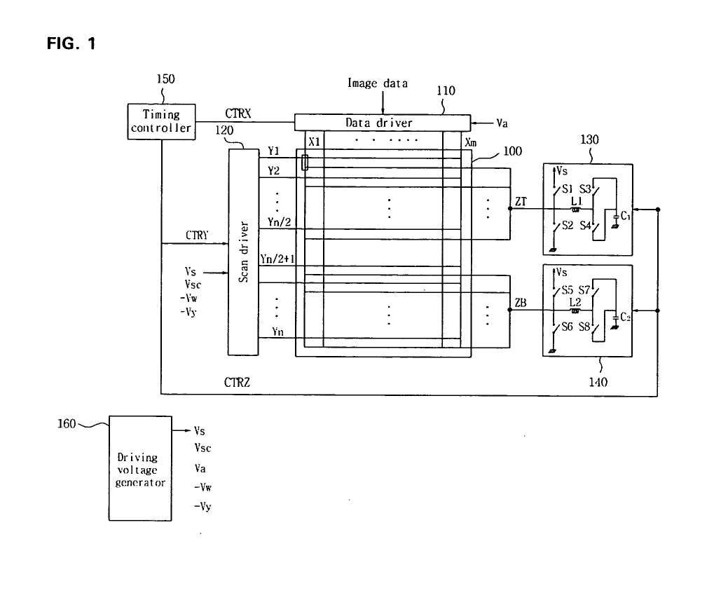

FIG. 1 illustrates a plasma display apparatus according to a first embodiment. As illustrated in FIG. 1, the plasma display apparatus according to the first embodiment comprises a plasma display panel 100, a data driver 110, a scan driver 120, a first sustain driver 130, a second sustain driver 140, a timing controller 150 and a driving voltage generator 160.

The plasma display panel 100 comprises scan electrodes Y1 to Yn and sustain electrodes ZT and ZB. The sustain electrodes ZT and ZB includes a first sustain electrode group ZT and a second sustain electrode group ZB. The sustain electrodes in each of the sustain electrode groups ZT and ZB are commonly connected. The scan electrodes corresponding to the first sustain electrode group ZT are scanned earlier than the scan electrodes corresponding to the second sustain electrode group ZB. The plasma display panel 100 further comprises address electrodes X1 to Xm intersecting the scan electrodes Y1 to Yn, the first sustain electrode group ZT and the second sustain electrode group ZB.

The data driver 110 supplies a data pulse corresponding to an image signal after performing an inverse-gamma correction process, a half-toning process and a subfield mapping process to the address electrodes X1 to Xm.

The scan driver 120 supplies a reset pulse to the scan electrodes Y1 to Yn during a reset period, thereby initializing a discharge cell. The reset pulse includes a setup pulse with a gradually rising voltage and a set-down pulse with a gradually falling voltage. The scan driver 120 sequentially supplies a scan pulse falling to a scan reference voltage Vsc and a scan voltage −Vy to the scan electrodes Y1 to Yn during an address period which follows the reset period, thereby selecting scan lines. The scan driver 120 supplies a sustain pulse to the scan electrodes Y1 to Yn during a sustain period which follows the address period, thereby generating a sustain discharge in the discharge cell selected during the address period.

The first sustain driver 130, under the control of the timing controller 150, supplies a bias voltage Vz having a positive sustain voltage Vs to the first sustain electrode group ZT during a set-down period of the reset period and the address period. Then, the first sustain driver 130 supplies a sustain pulse to the first sustain electrode group ZT during the sustain period. The scan driver 120 and the first sustain driver 130 alternately supply the sustain pulse.

The second sustain driver 140, under the control of the timing controller 150, supplies the bias voltage Vz having the positive sustain voltage Vs to the second sustain electrode group ZB during the set-down period. The second sustain driver 140 forms a gradually falling voltage in the second sustain electrode group ZB during at least a portion of a total period of time when the set-down pulse is supplied to the scan electrodes Y1 to Yn. By forming the gradually falling voltage in the second sustain electrode group ZB, a voltage difference between the second sustain electrode group ZB and the scan electrodes Y(n/2+1) to Yn corresponding to the second sustain electrode group ZB decreases. The second sustain driver 140 supplies the bias voltage Vz having the positive sustain voltage Vs to the second sustain electrode group ZB during the address period. Then, the second sustain driver 140 supplies a sustain pulse to the second sustain electrode group ZB during the sustain period. The scan driver 120 and the second sustain driver 140 alternately supply the sustain pulse.

The timing controller 150 receives a vertical/horizontal synchronization signal, and supplies timing control signals CTRX, CTRY and CTRZ to the drivers 110, 120, 130 and 140. The timing control signal CTRX supplied to the data driver 110 includes a sampling clock for sampling data, a latch control signal, and a switch control signal for controlling on/off time of a driving switch element. The timing control signal CTRY supplied to the scan driver 120 includes a switch control signal for controlling on/off time of an energy recovery circuit and a driving switch element inside the scan driver 120. The timing control signal CTRZ supplied to the first and second sustain drivers 130 and 140 includes a switch control signal for controlling on/off time of an energy recovery circuit and a driving switch element inside the first and second sustain drivers 130 and 140. In particular, the timing controller 150 supplies the timing control signal for forming the gradually falling voltage in the second sustain electrode group ZB to the second sustain driver 140 during at least a portion of the total period of time when the set-down pulse is supplied to the scan electrodes Y1 to Yn.

The driving voltage generator 160 produces various voltages necessary in the drivers 110, 120, 130 and 140, for example, a sustain voltage Vs, a scan reference voltage Vsc, a data voltage Va, a set-down voltage −Vw, a scan voltage −Vy. These driving voltages may vary in accordance with the composition of a discharge gas or the structure of the discharge cells.

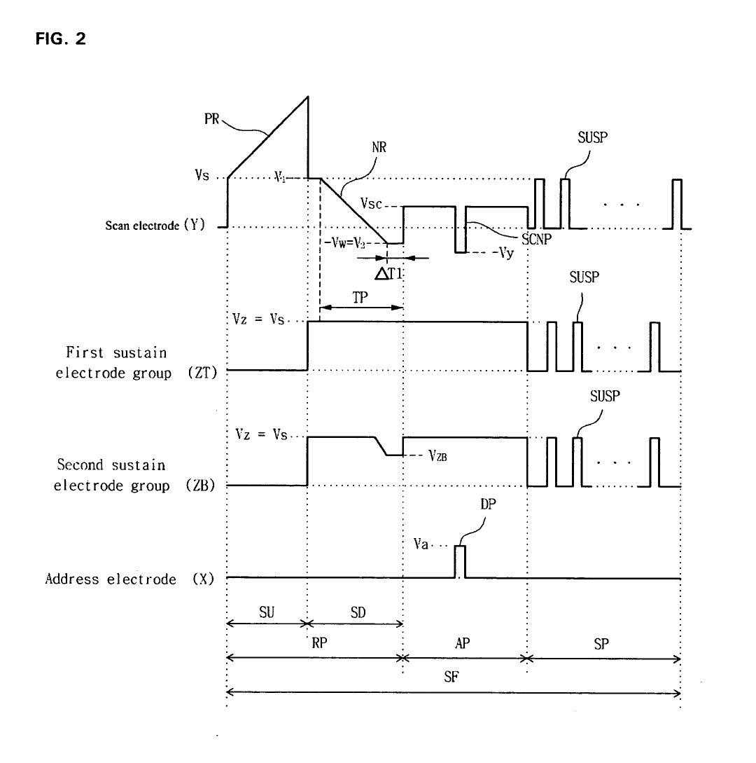

FIG. 2 illustrates a waveform of a driving signal of the plasma display apparatus according to the first embodiment. As illustrated in FIG. 2, the plasma display apparatus is driven by dividing each subfield into a reset period RP for initializing a discharge cell, an address period AP for selecting a discharge cell to be discharged and a sustain period SP for achieving gray level. The reset period is further divided into a setup period SU and a set-down period SD.

During the setup period SU of the reset period RP, the scan driver 120 simultaneously supplies a setup pulse PR having a positive slope to all the scan electrodes Y1 to Yn. The setup pulse PR generates a weak dark discharge (i.e., a setup discharge) within the discharge cells of the whole screen. This results in wall charges of a positive polarity being accumulated on the address electrodes X1 to Xm, the first sustain electrode group ZT and the second sustain electrode group ZB, and wall charges of a negative polarity being accumulated on the scan electrodes Y1 to Yn.

During the set-down period SD of the reset period RP, the scan driver 120 supplies a set-down pulse NR gradually falling from a first voltage V1 to a second voltage V2 to all the scan electrodes Y1 to Yn. The first sustain driver 130 supplies a bias voltage Vz having a positive sustin voltage Vs to the first sustain electrode group ZT.

During the reset period RP, there is no change in the amount of wall charges of the positive polarity accumulated on the address electrodes X1 to Xm. A proper amount of wall charges of the positive polarity accumulated on the first sustain electrode group ZT are erased due to a set-down discharge between the first sustain electrode group ZT and the scan electrodes Y1 to Yn/2, and a portion of the large amount of wall charges of the negative polarity accumulated on the scan electrodes Y1 to Yn/2 moves to the first sustain electrode group ZT. In other words, the remaining wall charges are uniform inside the cells to the extent that an address discharge can be stably performed.

During the set-down period SD, the second sustain driver 140 supplies the bias voltage Vz having the positive sustain voltage Vs to the second sustain electrode group ZB. Further, the second sustain driver 140 causes the second sustain electrode group ZB to be placed in a floating state during at least a portion of a total period TP of time when the set-down pulse NR is supplied to the scan electrodes Y1 to Yn. In other words, switches S5 to S8 of the second sustain driver 140, under the control of the timing controller 150, are turned off such that the second sustain electrode group ZB is placed in a floating state. Accordingly, a voltage gradually falling from the bias voltage Vz is formed in the second sustain electrode group ZB, and a voltage difference between the second sustain electrode group ZB and the scan electrodes Y(n/2+1) to Yn corresponding to the second sustain electrode group ZB decreases.

When the voltage difference between the second sustain electrode group ZB and the scan electrodes Y(n/2+1) to Yn corresponding to the second sustain electrode group ZB deceases, the intensity of the discharge between the second sustain electrode group ZB and the scan electrodes Y(n/2+1) to Yn is less than the intensity of the discharge between the first sustain electrode group ZT and the scan electrodes Y(n/2+1) to Yn. Accordingly, the amount of wall charges of the negative polarity remaining in the scan electrodes Y(n/2+1) to Yn is more than the amount of wall charges of the negative polarity remaining in the scan electrodes Y1 to Yn/2.

Since the scan electrodes Y(n/2+1) to Yn corresponding to the second sustain electrode group ZB is scanned later than the scan electrodes Y1 to Yn/2 corresponding to the first sustain electrode group ZT, it is a great likelihood of a loss of wall charges due to a coupling between space charges and wall charges within the discharge cell later the address period AP. Accordingly, when the voltage difference between the second sustain electrode group ZB and the scan electrodes Y(n/2+1) to Yn corresponding to the second sustain electrode group ZB decreases, the amount of wall charges of the negative polarity remaining in the scan electrodes Y(n/2+1) to Yn is more than the amount of wall charges of the negative polarity remaining in the scan electrodes Y1 to Yn/2, thereby reducing the instability of an address discharge generating within the discharge cells corresponding to the scan electrodes Y(n/2+1) to Yn. Further, the discharge intensity between the second sustain electrode group ZB and the scan electrodes Y(n/2+1) to Yn decreases, thereby improving contrast.

The second sustain driver 140 causes the second sustain electrode group ZB in the floating state without a separate circuit such that the voltage difference between the second sustain electrode group ZB and the scan electrodes Y(n/2+1) to Yn decreases. Accordingly, the manufacturing cost of the plasma display apparatus decreases.

To improve a contrast ratio of the plasma display apparatus by controlling the intensity of the set-down discharge and to erase a proper amount of wall charges accumulated during the setup period SU, a lowest voltage −Vw of the set-down pulse NR may be more than a lowest voltage −Vy of a scan pulse SCNP supplied to the scan electrodes Y1 to Yn during the address period AP.

The scan driver may maintain the set-down pulse NR at its lowest voltage −Vw for a predetermined period of time ΔT1. Since the set-down pulse NR is maintained at its lowest voltage −Vw for the predetermined period of time ΔT1, a state of the wall charges distributed within the discharge cell can be properly stabilized. The predetermined period of time ΔT1 may range from 10% to 50% of a total duration of the set-down period SD. When the predetermined period of time ΔT1 ranges from 10% to 50% of a total duration of the set-down period SD, the set-down discharge occurs at the proper intensity and a state of the wall charges distributed within the discharge cell is properly stabilized.

During the address period AP, the data driver 110 supplies a data pulse DP rising from a ground level voltage GND to a data voltage Va to the address electrodes X1 to Xm. The scan driver 120 supplies a scan pulse SCNP falling from the scan reference voltage Vsc to the scan voltage −Vy to the scan electrodes Y1 to Yn. As a voltage difference between the address electrodes X1 to Xm and the scan electrodes Y1 to Yn is added to the wall voltage generated during the reset period RP, the address discharge occurs.

During the address period AP, the first sustain driver 130 and the second sustain driver 140 supply the bias voltage having the sustain voltage Vs to the first sustain electrode group ZT and the second sustain elected group ZB, respectively.

During the sustain period SP, the first sustain driver 130 and the second sustain driver 140 supply a sustain pulse SUSP rising from a ground level voltage to the sustain voltage Vs to the first sustain electrode group ZT and the second sustain electrode group ZB, respectively. The scan driver 120 supplies a sustain pulse SUSP rising from a ground level voltage to the sustain voltage Vs to the scan electrodes Y1 to Yn. The scan driver 120 and the first sustain driver 130 and the second sustain driver 140 operate alternately.

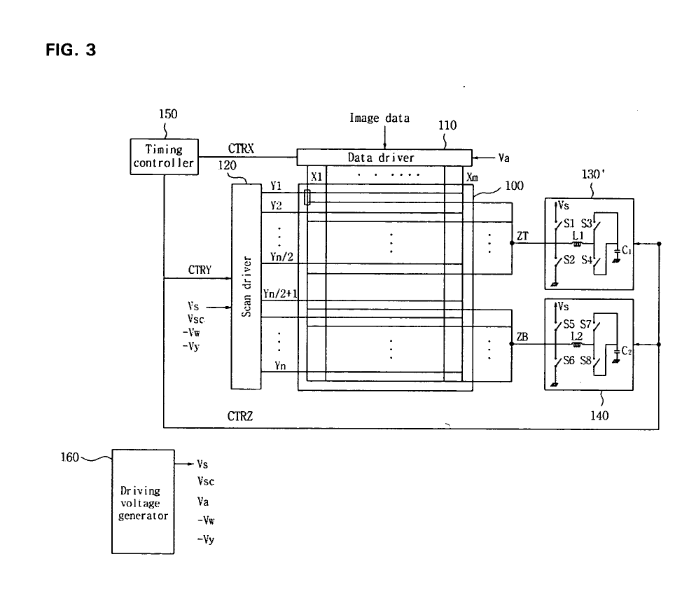

FIG. 3 illustrates a plasma display apparatus according to a second embodiment. Since a plasma display panel 100, a data driver 110, a scan driver 120 and a driving voltage generator 160 of the plasma display apparatus according to the second embodiment are the same as those of the plasma display apparatus according to the first embodiment, a description thereof is omitted.

A first sustain driver 130′ drives a first sustain electrode group ZT. The first sustain driver 130′, under the control of the timing controller 150, forms a gradually falling voltage in the first sustain electrode group ZT. In other words, the first sustain driver 130′ forms a gradually falling voltage in the first sustain electrode group ZT during at least a portion of a total period of time when a set-down pulse is supplied to the scan electrodes Y1 to Yn.

A second sustain driver 140 drives a second sustain electrode group ZB. The second sustain driver 140, under the control of the timing controller 150, forms a gradually falling voltage in the second sustain electrode group ZB. In other words, the second sustain driver 140 forms a gradually falling voltage in the second sustain electrode group ZB during at least a portion of the total period of time when the set-down pulse is supplied to the scan electrodes Y1 to Yn.

In the plasma display apparatus according to the second embodiment, a duration of a period during which the first sustain driver 130′ forms the gradually falling voltage is less than a duration of a period during which the second sustain driver 140 forms the gradually falling voltage.

The timing controller 150 outputs a control signal for forming the gradually falling voltage by the first sustain driver 130′ and the second sustain driver 140.

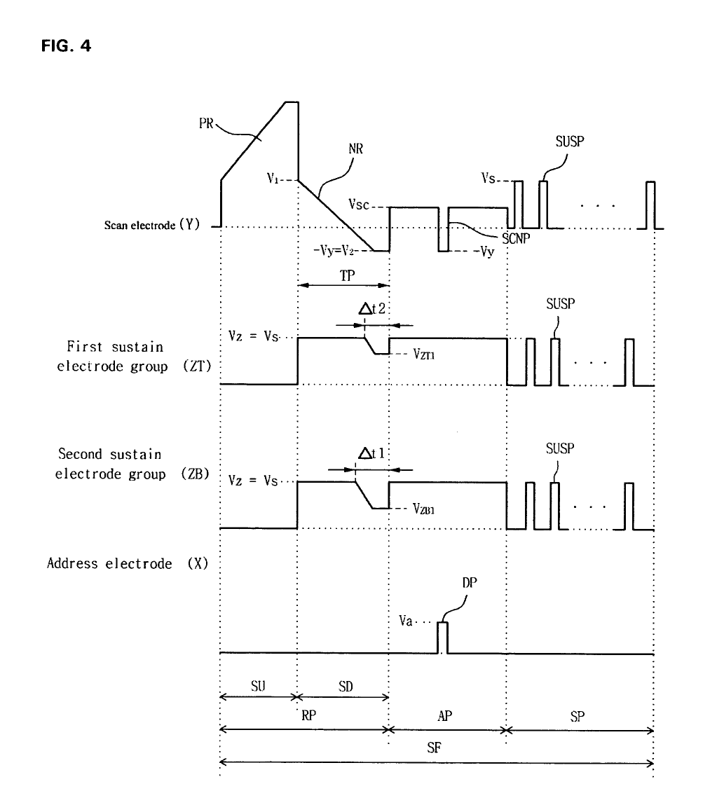

FIG. 4 illustrates a waveform of a driving signal of the plasma display apparatus according to the second embodiment. As illustrated in FIG. 4, the plasma display apparatus is driven by dividing each subfield into a reset period RP for initializing a discharge cell, an address period AP for selecting a discharge cell to be discharged and a sustain period SP for achieving gray level. The reset period is further divided into a setup period SU and a set-down period SD.

During the setup period SU of the reset period RP, the scan driver 120 simultaneously supplies a setup pulse PR having a positive slope to all the scan electrodes Y1 to Yn. The setup pulse PR generates a weak dark discharge (i.e., a setup discharge) within the discharge cells of the whole screen. This results in wall charges of a positive polarity being accumulated on the address electrodes X1 to Xm, the first sustain electrode group ZT and the second sustain electrode group ZB, and wall charges of a negative polarity being accumulated on the scan electrodes Y1 to Yn.

During the set-down period SD of the reset period RP, the scan driver 120 supplies a set-down pulse NR gradually falling from a first voltage V1 to a second voltage V2 to all the scan electrodes Y1 to Yn. In the second embodiment, the second voltage V2 is substantially equal to a lowest voltage −Vy of a scan pulse SCNP.

The first sustain driver 130′ and the second sustain driver 140 supply a bias voltage Vz having a positive sustain voltage Vs to the first sustain electrode group ZT and the second sustain electrode group ZB during at least a portion of the set-down period.

Accordingly, during the reset period RP, there is no change in the amount of wall charges of the positive polarity accumulated on the address electrodes X1 to Xm. A proper amount of wall charges of the positive polarity accumulated on each of the first sustain electrode group ZT and the second sustain electrode group ZB are erased due to a discharge between the first sustain electrode group ZT and the scan electrodes Y1 to Yn/2 and a discharge between the second sustain electrode group ZB and the scan electrodes Y(n/2+1) to Yn. A portion of the large amount of wall charges of the negative polarity accumulated on the scan electrodes Y1 to Yn moves to the first sustain electrode group ZT and the second sustain electrode group ZB.

The first sustain driver 130′ causes the first sustain electrode group ZT to be placed in a floating state during at least a portion (i.e., a second period Δt2) of a total period TP of time when the set-down pulse NR is supplied to the scan electrodes Y1 to Yn. Further, the second sustain driver 140 cause the second sustain electrode group ZB to be placed in a floating state during at least a portion (i.e., a first period Δt1) of a total period TP of time when the set-down pulse NR is supplied to the scan electrodes Y1 to Yn. More specifically, switches S1 to S4 of the first sustain driver 130′, under the control of the timing controller 150, are turned off such that the first sustain electrode group ZT is placed in a floating state. Further, switches S5 to S8 of the second sustain driver 140, under the control of the timing controller 150, are turned off such that the second sustain electrode group ZB is placed in a floating state.

Accordingly, a voltage gradually falling from the bias voltage Vz is formed in each of the first sustain electrode group ZT and the second sustain electrode group ZB. A voltage difference between the first sustain electrode group ZT and the scan electrodes Y1 to Yn/2 and a voltage difference between the second sustain electrode group ZB and the scan electrodes Y(n/2+1) to Yn decrease.

Since a duration of the first period Δt1 is more than a duration of the second period Δt2, the intensity of the discharge between the second sustain electrode group ZB and the scan electrodes Y(n/2+1) to Yn is less than the intensity of the discharge between the first sustain electrode group ZT and the scan electrodes Y1 to Yn/2. Accordingly, the amount of wall charges of the negative polarity remaining in the scan electrodes Y(n/2+1) to Yn is more than the amount of wall charges of the negative polarity remaining in the scan electrodes Y1 to Yn/2.

Since the scan electrodes Y(n/2+1) to Yn corresponding to the second sustain electrode group ZB is scanned later than the scan electrodes Y1 to Yn/2 corresponding to the first sustain electrode group ZT, it is a great likelihood of a loss of wall charges due to a coupling between space charges and wall charges within the discharge cell later the address period AP. However, since the amount of wall charges of the negative polarity remaining in the scan electrodes Y(n/2+1) to Yn is more than the amount of wall charges of the negative polarity remaining in the scan electrodes Y1 to Yn/2, the instability of an address discharge generating within the discharge cells corresponding to the scan electrodes Y(n/2+1) to Yn decreases. Further, the discharge intensity between the first sustain electrode group ZT and the scan electrodes Y1 to Yn/2 and the discharge intensity between the second sustain electrode group ZB and the scan electrodes Y(n/2+1) to Yn decrease, thereby improving contrast.

The first sustain driver 130′ and the second sustain driver 140 cause the first sustain electrode group ZT and the second sustain electrode group ZB in the floating state without a separate circuit such that the voltage difference between the first sustain electrode group ZT and the scan electrodes Y1 to Yn/2 and the voltage difference between the second sustain electrode group ZB and the scan electrodes Y(n/2+1) to Yn decreases. Accordingly, the manufacturing cost of the plasma display apparatus decreases.

During the address period AP, the scan driver 120 sequentially supplies the scan pulse SCNP falling from a positive scan reference voltage Vsc to the scan voltage −Vy to the scan electrodes Y1 to Yn. During the sustain period SP, the scan driver 120 supplies a sustain pulse SUSP to the scan electrodes Y1 to Yn.

During the address period AP, the first sustain driver 130′ and the second sustain driver 140 supply the bias voltage having the sustain voltage Vs to the first sustain electrode group ZT and the second sustain electrode group ZB, respectively. During the sustain period SP, the first sustain driver 130′ and the second sustain driver 140 supply a sustain pulse SUSP to the first sustain electrode group ZT and the second sustain electrode group ZB, respectively.

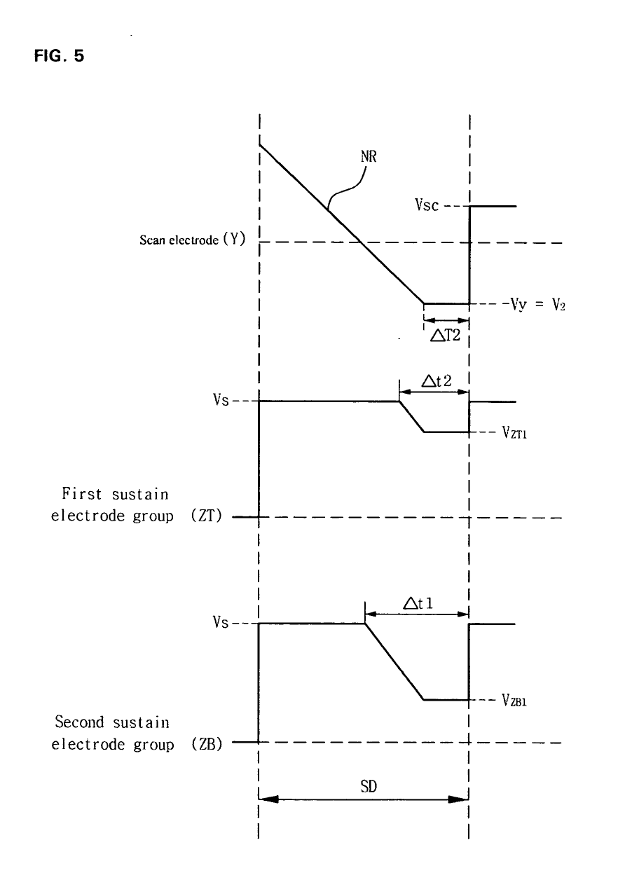

FIG. 5 illustrates a driving signal supplied during a set-down period in the driving signal of the plasma display apparatus according to the second embodiment. As illustrated in FIG. 5, the duration of the first period Δt1, during which the second sustain electrode group ZB is placed in the floating state, is more than the duration of the second period Δt2, during which the first sustain electrode group ZT is placed in the floating state. A lowest voltage level VZB1 of the gradually falling voltage formed in the second sustain electrode group ZB is less than a lowest voltage level VZT1 of the gradually falling voltage formed in the first sustain electrode group ZT.

The lowest voltage V2 of the set-down pulse NR may be substantially equal to the lowest voltage −Vy of the scan pulse SCNP. Accordingly, since a single voltage source produces both the set-down pulse NR and the scan pulse SCNP, the manufacturing cost of the plasma display apparatus decreases.

The scan driver 120 may maintain the set-down pulse NR at its lowest voltage −Vy for a predetermined period of time ΔT2. Since the set-down pulse NR is maintained at its lowest voltage −Vw for the predetermined period of time ΔT2, a state of the wall charges distributed within the discharge cell can be properly stabilized. The predetermined period of time ΔT2 may range from 10% to 50% of a total duration of the set-down period SD. When the predetermined period of time ΔT1 ranges from 10% to 50% of a total duration of the set-down period SD, the set-down discharge occurs at the proper intensity and a state of the wall charges distributed within the discharge cell is properly stabilized.

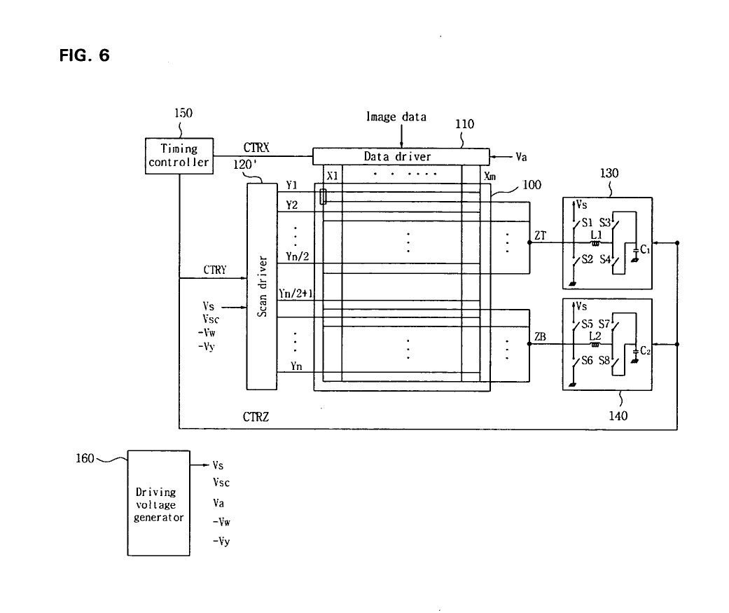

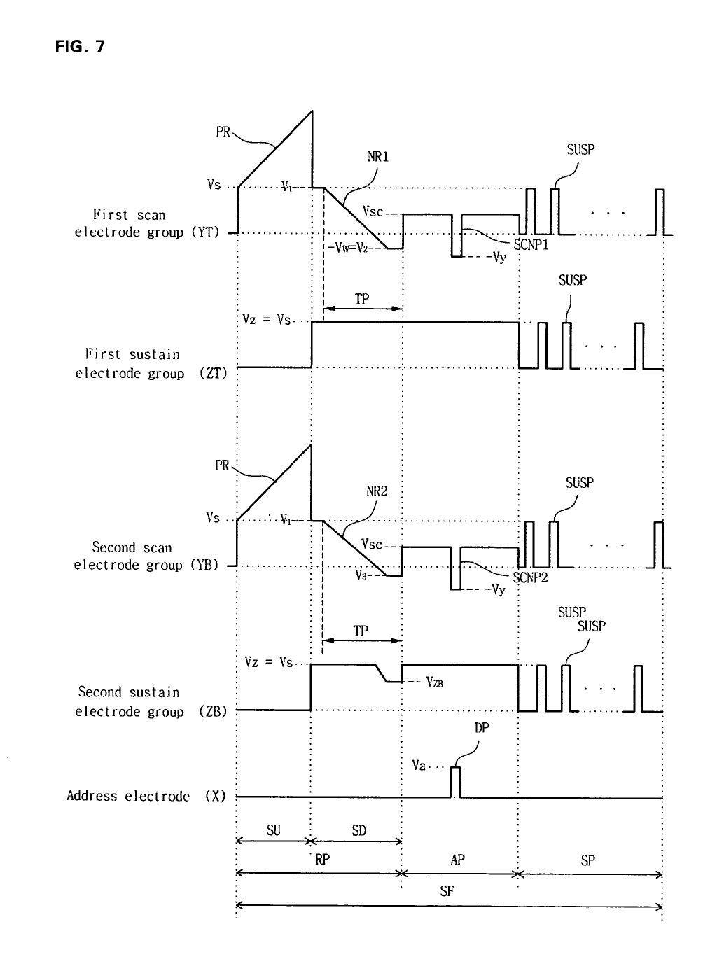

FIG. 6 illustrates a plasma display apparatus according to a third embodiment. FIG. 7 illustrates a waveform of a driving signal of the plasma display apparatus according to the third embodiment. Since a plasma display panel 100, a data driver 110 and a driving voltage generator 160 of the plasma display apparatus according to the third embodiment are the same as those of the plasma display apparatus according to the first embodiment, a description thereof is omitted.

During a set-down period SD, a scan driver 120′ supplies a first set-down pulse NR1 falling from a first voltage V1 to a second voltage V2 to a first scan electrode group YT, and a second set-down pulse NR2 falling from the first voltage V1 to a third voltage V3 more than the second voltage V2 to a second scan electrode group YB. During an address period AP, the scan driver 120′ supplies a first scan pulse SCNP1 to the first scan electrode group YT and a second scan pulse SCNP2 to the second scan electrode group YB. The first scan electrode group YT includes the scan electrode Y1 to the scan electrode Yn/2, and the second scan electrode group YB includes the scan electrode Y(n/2+1) to the scan electrode Yn.

During the set-down period SD, a first sustain driver 130 supplies a bias voltage Vz to a first sustain electrode group ZT.

A second sustain driver 140 forms a gradually falling voltage in a second sustain electrode group ZB during at least a portion of a total period TP of time when the second set-down pulse NR2 is supplied to the second scan electrode group YB.

A timing controller 150 outputs a timing control signal for turning off switches S5 to S8 of the second sustain driver 140. Accordingly, the second sustain driver 140 causes the second sustain electrode group ZB to be placed in a floating state such that a gradually falling voltage is formed in the second sustain electrode group ZB.

Since the second voltage V2 of the first set-down pulse NR1 supplied to the first scan electrode group YT, which is scanned earlier than the second scan electrode group YB, is less than the third voltage V3 of the second set-down pulse NR2, an erase amount of wall charge remaining in the first scan electrode group YT is more than an erase amount of wall charge remaining in the second scan electrode group YB. Further, the gradually falling voltage is formed in the second sustain electrode group ZB such that the voltage difference between the second scan electrode group YB and the second sustain electrode group ZB decreases.

Since the second scan electrode group YB is scanned later than the first scan electrode group YT, it is a great likelihood of a loss of wall charges due to a coupling between space charges and wall charges within the discharge cell later the address period AP. However, in the third embodiment, since a difference between the amount of wall charges remaining in the first scan electrode group YT and the amount of wall charges remaining in the second scan electrode group YB decreases, the address discharge occurs stably. Further, intensity of a discharge between the second scan electrode group YB and the second sustain electrode group ZB decrease, thereby improving contrast.

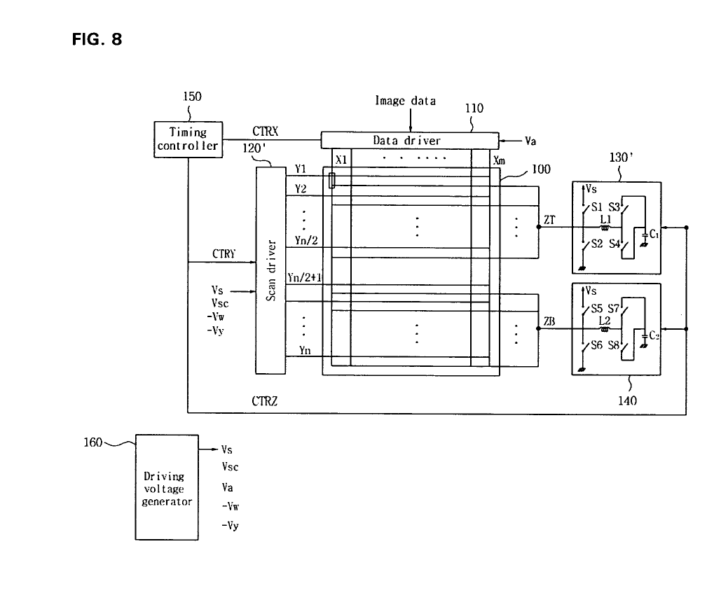

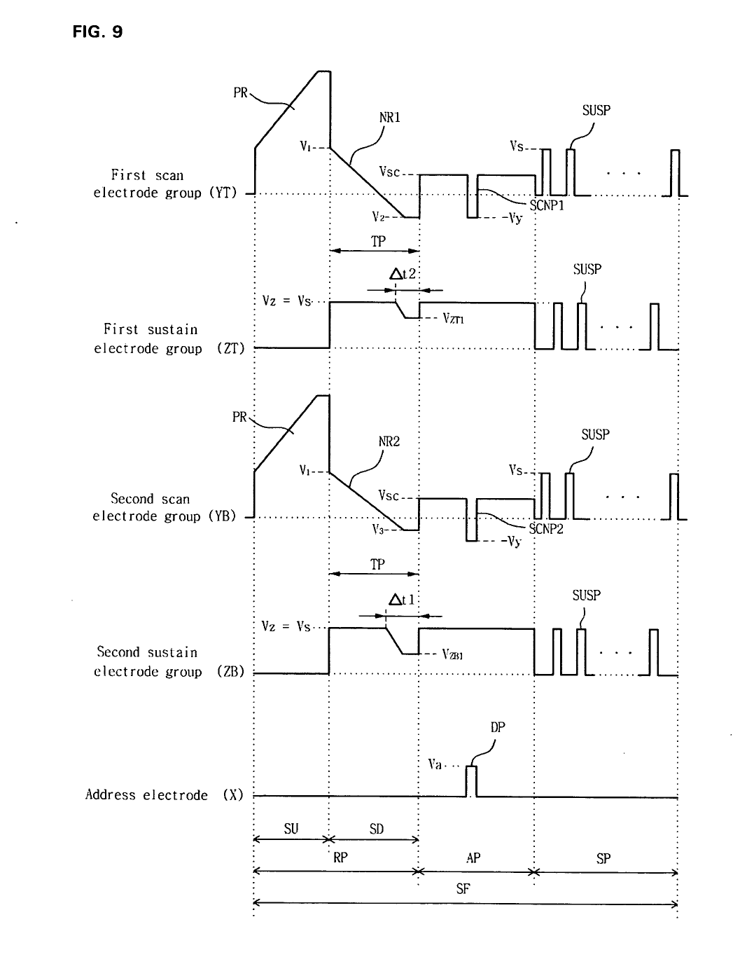

FIG. 8 illustrates a plasma display apparatus according to a fourth embodiment. FIG. 9 illustrates a waveform of a driving signal of the plasma display apparatus according to the fourth embodiment. Since a plasma display panel 100, a data driver 110 and a driving voltage generator 160 of the plasma display apparatus according to the fourth embodiment are the same as those of the plasma display apparatus according to the first embodiment, a description thereof is omitted.

During a set-down period SD, a scan driver 120′ supplies a first set-down pulse NR1 falling from a first voltage V1 to a second voltage V2 to a first scan electrode group YT, and a second set-down pulse NR2 falling from the first voltage V1 to a third voltage V3 more than the second voltage V2 to a second scan electrode group YB. During an address period AP, the scan driver 120′ supplies a first scan pulse SCNP1 to the first scan electrode group YT and a second scan pulse SCNP2 to the second scan electrode group YB. The first scan electrode group YT includes the scan electrode Y1 to the scan electrode Yn/2, and the second scan electrode group YB includes the scan electrode Y(n/2+1) to the scan electrode Yn.

A first sustain driver 130′ forms a gradually falling voltage in a first sustain electrode group ZT during at least a portion (i.e., a period Δt2) of a total period TP of time when the first set-down pulse NR1 is supplied to the first scan electrode group YT.

A second sustain driver 140 forms a gradually falling voltage in a second sustain electrode group ZB during at least a portion (i.e., a period Δt1) of a total period TP of time when the second set-down pulse NR2 is supplied to the second scan electrode group YB.

A timing controller 150 outputs a timing control signal for turning off switches S1 to S4 of the first sustain driver 130′ and switches S5 to S8 of the second sustain driver 140. Accordingly, the first sustain driver 130′, the second sustain driver 140 cause the first sustain electrode group ZT and the second sustain electrode group ZB to be placed in a floating state such that a gradually falling voltage is formed in the first sustain electrode group ZT and the second sustain electrode group ZB.

Since the second voltage V2 of the first set-down pulse NR1 supplied to the first scan electrode group YT, which is scanned earlier than the second scan electrode group YB, is less than the third voltage V3 of the second set-down pulse NR2, an erase amount of wall charge remaining in the first scan electrode group YT is more than an erase amount of wall charge remaining in the second scan electrode group YB.

Accordingly, since a difference between the amount of wall charges remaining in the first scan electrode group YT and the amount of wall charges remaining in the second scan electrode group YB decreases, an address discharge occurs stably. Further, intensity of a discharge between the first scan electrode group YT and the first sustain electrode group ZT and intensity of a between the second scan electrode group YB and the second sustain electrode group ZB decrease, thereby improving contrast.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a first scan electrode supplied with a first scan pulse, a second scan electrode supplied with a second scan pulse after supplying the first scan pulse, a first sustain electrode corresponding to the first scan electrode, and a second sustain electrode corresponding to the second scan electrode;
a scan driver for supplying a set-down pulse falling from a first voltage to a second voltage to the first scan electrode and the second scan electrode during a set-down period, and for supplying the first scan pulse to the first scan electrode and the second scan pulse to the second scan electrode during an address period; and
a sustain driver for forming a gradually falling voltage in the second sustain electrode during at least a portion of a total period of time when the set-down pulse is supplied.

2. The plasma display apparatus of claim 1, wherein the sustain driver causes the second sustain electrode to be placed in a floating state to form the gradually falling voltage in the second sustain electrode.

3. The plasma display apparatus of claim 1, further comprising another sustain driver for supplying a bias voltage to the first sustain electrode during the set-down period.

4. The plasma display apparatus of claim 1, further comprising another sustain driver for forming a gradually falling voltage in the first sustain electrode during a second period of a duration less than a duration of a first period during which the gradually falling voltage is formed in the second sustain electrode.

5. The plasma display apparatus of claim 4, wherein the another sustain driver causes the first sustain electrode to be placed in a floating state to form the gradually falling voltage in the first sustain electrode.

6. The plasma display apparatus of claim 1, wherein the second voltage is more than a lowest voltage of the first scan pulse and a lowest voltage of the second scan pulse.

7. The plasma display apparatus of claim 1, wherein the second voltage is substantially equal to a lowest voltage of the first scan pulse and a lowest voltage of the second scan pulse.

8. The plasma display apparatus of claim 1, wherein a voltage of the set-down pulse supplied to the first scan electrode and the second scan electrode is maintained at the second voltage for a predetermined period of time.

9. The plasma display apparatus of claim 8, wherein the predetermined period of time ranges from 10% to 50% of a total duration of the set-down period.

10. A method of driving a plasma display apparatus comprising a first scan electrode, a second scan electrode, a first sustain electrode corresponding to the first scan electrode and a second sustain electrode corresponding to the second scan electrode, the method comprising:
supplying a set-down pulse falling from a first voltage to a second voltage during a set-down period to the first scan electrode and the second scan electrode;
forming a gradually falling voltage in the second sustain electrode during at least a portion of a total period of time when the set-down pulse is supplied to the second scan electrode;
supplying the first scan pulse to the first scan electrode; and
supplying the second scan pulse to the second scan electrode.

11. The method of claim 10, wherein the second sustain electrode is placed in a floating state to form the gradually falling voltage in the second sustain electrode.

12. The method of claim 10, wherein a bias voltage is supplied to the first sustain electrode during the set-down period.

13. The method of claim 10, wherein a gradually falling voltage is formed in the first sustain electrode during a second period of a duration less than a duration of a first period during which the gradually falling voltage is formed in the second sustain electrode.

14. The method of claim 13, wherein the first sustain electrode is placed in a floating state to form the gradually falling voltage in the first sustain electrode.

15. The method of claim 10, wherein the second voltage is more than a lowest voltage of the first scan pulse and a lowest voltage of the second scan pulse.

16. The method of claim 10, wherein the second voltage is substantially equal to a lowest voltage of the first scan pulse and a lowest voltage of the second scan pulse.

17. The method of claim 10, wherein a voltage of the set-down pulse supplied to the first scan electrode and the second scan electrode is maintained at the second voltage for a predetermined period of time.

18. The method of claim 17, wherein the predetermined period of time ranges from 10% to 50% of a total duration of the set-down period.

19. A plasma display apparatus comprising:
a plasma display panel comprising a first scan electrode supplied with a first scan pulse, a second scan electrode supplied with a second scan pulse after supplying the first scan pulse, a first sustain electrode corresponding to the first scan electrode, and a second sustain electrode corresponding to the second scan electrode;
a scan driver for supplying a first set-down pulse falling from a first voltage to a second voltage to the first scan electrode and a second set-down pulse falling from the first voltage to a third voltage with a magnitude more than a magnitude of the second voltage to the second scan electrode during a set-down period, and for supplying the first scan pulse to the first scan electrode and the second scan pulse to the second scan electrode during an address period; and
a sustain driver for forming a gradually falling voltage in the second sustain electrode during at least a portion of a total period of time when the second set-down pulse is supplied to the second scan electrode.

20. The plasma display apparatus of claim 19, wherein the sustain driver causes the second sustain electrode to be placed in a floating state to form the gradually falling voltage in the second sustain electrode.

21. The plasma display apparatus of claim 19, further comprising another sustain driver for supplying a bias voltage to the first sustain electrode during the set-down period.

22. The plasma display apparatus of claim 19, further comprising another sustain driver for forming a gradually falling voltage in the first sustain electrode during a period of time shorter than a period of time during which a voltage difference between the second scan electrode and the second sustain electrode decreases.

23. The plasma display apparatus of claim 22, wherein the another sustain driver causes the first sustain electrode to be placed in a floating state to form the gradually falling voltage in the first sustain electrode.
